(19) United States
(12) Patent Application Publication
(10) Pub. No.: US 2019/0336378 A1
(43) Pub. Date: Nov. 7, 2019

(54) METHOD FOR TREATING AND PREVENTING PERIPHERAL CIRCULATION DISORDERS AND INVERSION TABLE FOR THE IMPLEMENTATION THEREOF

(71) Applicant: OBCHECTVO S OGRANICHENNOY OTVETSTVENNOSTIY "BELMED INNOVATSIA", Minsk (BY)

(72) Inventors: Ekaterina Evgenyevna LADOZHSKAYA-GAPEENKO, St.Petersburg (RU); Sergei Nikolaevich LADOZHSKAYA-GAPEENKO, St.Petersburg (RU)

(73) Assignee: OBCHECTVO S OGRANICHENNOY OTVETSTVENNOSTIY "BELMED INNOVATSIA", Minsk (BY)

(21) Appl. No.: 16/077,769

(22) PCT Filed: Feb. 15, 2017
(86) PCT No.: PCT/EA2017/000002

§ 371 Date: Aug. 14, 2018

(30) Foreign Application Priority Data
Feb. 22, 2016 (EA) 201600260

(51) Int. Cl. A61H 1/02; A61H 1/00

(52) U.S. Cl. CPC A61H 1/0229; A61H 1/003; A61H 1/005; A61H 2001/0203; A61H 2209/00; A61H 2201/123; A61H 2201/1678; A61H 2203/0456; A61H 2201/0142

(57) ABSTRACT

The invention relates to medicine, and more particularly to gravitational therapy, and can be used independently or as part of a programme of treatment and rehabilitation for patients with peripheral circulation disorders. The present inversion table consists of a bed with a pivotable frame, and a support element. A treatment and prevention method involves positioning a patient on the inversion table such that they are lying on their right side with their legs bent at the knees and apart at the hips, and inclining the head portion of the table by an angle of up to 30 degrees and returning the table to its initial position by means of oscillating movements performed about the longitudinal and transverse axes with a set frequency. The frequency is set such as to be equal to the average value of the frequencies of the oscillations in the skin microcirculation with a maximum amplitude.

### CROSS-REFERENCE TO RELATED APPLICATIONS

The present patent application is a National stage application of the PCT patent application PCT/EA2017/000002 filed Feb. 15, 2017, which claims priority to Russian patent application RU201600260 filed Feb. 22, 2016.

### FIELD OF THE INVENTION

The invention is related to medicine, gravitation-based therapy in particular; it can be used alone or in complex treatment and rehabilitation of patients with peripheral blood circulation disorders.

### BACKGROUND

Circulatory disorders are among the most acute problems of the academic medicine and healthcare practice of the 2^{nd} half of the 20^{th} century and early 21^{st} century. They constitute the leading cause of death in most global development economies including Russia. In our country, circulatory disorders constitute the leading cause of disability and death.

At present, diseases caused by peripheral circulatory disorders are medicated with a group of preparations that improve peripheral circulation, i.e., vasoprotectives, calcium channel blockers that enhance cerebrovascular microcirculation and make a cerebroprotective, i.e., restoring effect.

Myotropic spasmolytics, bioflavonoids, ganglionic blockers, alpha-blockers are widely used for peripheral circulation disorders to improve circulation in peripheral tissues and organs.

There is a known method for treating patients with chronic arterial insufficiency of the lower extremities laser Doppler flowmetry (RU 2162356). This method provides for preliminary detection of vasomotion frequency with a laser Doppler flowmeter to synchronize the laser impact mode. Patients with obliterative artery disease of the lower extremities get better microdynamics and collateral circulation in the lower extremities, lower level of ischemic manifestations, higher foot temperature, their pain-free walking distance is increased 3.2 times on average, and their trophic wounds are healed much faster. This method is applied for treating the lower extremities.

There is a known orthostatic method for treating and preventing vascular insufficiency in the cerebrum and body tissues (L. K. Rozlomiy, The Art of Healing, published at http://www.xliby.ru/zdorove/iskusstvo_vrachevanija/p12.php) that consists in placing the patient on a special table with a triangle basis and a flat surface installed and fixed on top; the surface has soft and spacious trimming and is capable of tilting against the relatively immovable triangle base: alternatively raising and lowering the table head end. The table has a belt that, along with the soft table trimming, prevents the patient from sliding down on the tilted surface. The patient lies in the supine position on the table fixed in the neutral position, when the table head and foot ends are leveled out, and the table plane is horizontal. After belting the patient down, the table head end is lowered at a certain velocity down to an angle of 5-30 degrees. After holding the table in the extreme position for about 10 seconds, the head end is lifted to the horizontal level and up to the same degree. The time of holding the table in the upper-position may be equal to the lower-position time, or longer. After altering these movements for a certain time, the procedure is concluded with the table head end in the upper position.

The method's disadvantage is that the static gravitational effect on the upper body entails such reflex reactions, as high blood pressure and disorders of venous outflow from vital organs. The treatment does not provide for improvements of the microcirculation in the cerebrum, heart and longs; a serious skin blood flow is observed.

There is a known method (chosen as the prototype) of integrated treatment and rehabilitation of neurologic, cardiologic and therapeutic-profile patients with circulatory deficiency. The patient is placed in the right lateral position with their legs bent in knees and spread apart in hip joints. The method is performed on a horizontal inversion table with a gradual decline of the table head to a set tilt angle. The table head is declined and reset by continuous tilting at a variable angle of rotation along the longitudinal and transverse axes.

The method's disadvantage is that it can be used for efficient treatment of neurologic, cardiologic and therapeutic-profile patients with circulatory deficiency only.

The known method is implemented with the use of the inversion table described in utility model patent RU 145871. The inversion table, which is used for making a healing effect on the patient, consists of a support element with a framed counter; two drives providing for complex rotation of the counter in two planes; a mattress snap-fastened to the counter. The device also has soft belts for fastening the patient in the thigh/hip area, and a soft-material fixture for spreading the patient's thighs.

The technical result of the claimed invention is the improvement of the efficiency of treatment of patients' insufficient circulation-related diseases, as a result of the application of a personal approach and elimination of the deficiencies of the existing methods. The new enhanced table structure makes it comfortable for the patient and convenient for transportation and operation. Moreover, the new inversion table supports strict correspondence with the set operation modes, which greatly improves the method efficiency.

### BRIEF DESCRIPTION OF THE DRAWINGS

The key elements of the inversion table are shown on FIGS. 1-6.

FIG. 1 shows the base.

Base 1 is designed for:
transferring the load arising in allowable procedural positions, from the patient's bed to vertical supports 8 with struts 5
hinging rocker arm 12 and securing its special stability during the procedures
hinging the rocker arm drive actuator/motor for transverse rolling

The base has the form of a rectangular flat frame structure with two rigidly fixed vertical supports 8.

The base corners are outfitted with hinges 4 for mounting console supports 7 that help enlarge the support base of the structure.

The product has four pivotable supports 7 designed for enlarging the support base of the structure. The pivotable supports are hinged to its base. The pivotable supports also help reduce the shipping dimensions of the base.

Each pivotable console support has an adjustable stand for controlling the height of the console supports to make up for uneven floors.

The console supports are locked in place with retainer plate and star knob 17 (FIG. 2).

The strutless base 3 is designed for supporting the rocker arm in the original/horizontal position. In order to temper the contact of the support the rocker arm metallic structure, the support is outfitted with transverse board 3 that has rubberized shock pads 14 (FIG. 2).

FIG. 2 shows the rocker arm.

Rocker arm 12 is designed for
hinging pivotable frame 18 (FIG. 3) of bed 32 (FIG. 6)
mounting drive actuator 21 (FIG. 3) of pivotable frame 18 (FIG. 3) of bed 32 (FIG. 6)
Alidades 9 are mounted on the rocker arm structure in line with the rocker arm axis and the bed base axis. The alidades enable setting the bed tilt angles during the table operation. The alidades are fixed with brackets 22 (FIG. 3).

Springs 16 help mitigate the actuator-driven acceleration operating under load.

The rocker arm has two pairs of lugs 15 oriented along the table longitudinal axis for mounting rolling-element bearings (covered with the lugs) in each paired lug.

The bearings help avoid friction, which results in the absence of backlashes.

There is another pair of lugs with bearings 13 for mounting the actuator for the rocker arm transverse rolling.

The rocker arm is fixed with two bearings that are installed on axis 10 and fixed in support stands 8.

FIG. 3 shows the bed pivotable frame.

Bed pivotable frame 18 is designed for longitudinal rolling and rigid mounting of bed base 28 (FIG. 4).

The pivotable frame is outfitted with two lugs 20 for mounting the actuator rod axis 21. Bearings are set on the actuator rod axis

The lugs on the actuator rod axis are fixed/concealed in the lugs.

To ensure rigid mounting to the bed base frame, four 16 mm outer diameter tubes 23 with are welded onto the frame longitudinal rods. Thus, the tube tips project 25 mm above the frame rods in the direction of the attached bed frame.

Bracket 22 (FIG. 3) is fixed on the pivotable frame for mounting alidade 9 (FIG. 2).

Actuator 19 is mounted on the pivotable frame for fastening and loosening patient safety belt 31 (FIG. 6).

FIG. 4 shows the bed base.

Bed base 28 is designed for mounting:
bed 32
bracket with guide bar 25 of the patient safety belt
guide 24.

To secure rigid mounting of bed 28 on bed pivotable frame 18 (FIG. 3), four bushings 27 are fixed on the bed base for installation on bed pivotable frame tubes 23 (FIG. 3). Bushings 27 are drilled through with M10 thread on the ends. The bushings are partially drilled for fitting diameter F16 (support) tubes 23 (FIG. 3) of the bed pivotable frame. The bed base is rigidly fixed to the bed pivotable frame with four M10 bolts.

FIG. 5 shows the bed.

Bed 32 is designed for safe accommodation of the patient on the bed in the bed positions according to the procedure.

Level 29 is mounted on the bed rear side 32; it is designed for adjusting the bed position against the horizontal plane.

FIG. 6 shows the bed assembly.

Fencing 30 is designed for safe accommodation of the patient on the bed in the bed positions according to the procedure.

Safety belts with the patient belt (bandage strap) 31 are designed for safe accommodation of the patient on the bed in the bed positions according to the procedure.

FIG. 7 shows table control panel.

The layout of the table control panel is shown on the figure.

### SUMMARY

The inversion table consists of a bed with a pivotable frame, a support element for hinging actuators that provide for the bed longitudinal and traverse tilting; it has a soft-material fastener fixed in the pelvic area. The support element has a diagonal flat frame base with hinges on the corners for mounting pivotable console supports that enlarge the support base.

Two support stands with struts and two support stands with a traverse bar link are located near the corners on the long opposite sides of the base flat frame structure. A rocker arm is fixed with bearings on the axis linking the strutted stands. The rocker arm drive actuator, which provides for transverse tilting, is attached to the base. The rocker arm houses alidades lined with the rocker arm and pivotable frame axes. The pivotable frame drive actuator, which provides for longitudinal tilting, is attached to the rocker arm. The bed is rigidly fixed to the pivotable frame with longitudinal offset provided by the bed base fasteners and bolts. To secure the bed horizontal positioning, a level is installed on the rear side thereof, and each console support is provided with a height-adjustable stand. The console stands can be locked in place with a retainer plate and a star knob.

Four bushings are mounted on the bed base, providing for an option of their installation on the 4 pivotable frame tubes. The bushings are drilled through and threaded at the end for bolting down the bed. The bed may be outfitted with fencing.

The pelvic area fastener is a safety belt.

An actuator may be mounted on the pivotable frame for fastening and loosening the safety belt.

This inversion table fundamentally differs from the utility model by the following parameters:

The removal bed allows decreasing the movable table weight and bring the table through min 750 mm openings, which is very important, as most doors are sized 2,000×900 mm.

The bed pivotable frame provides for rigid mounting of the bed without any backlashes. That ensures strict compliance with the cycle sequence. The bed and pivotable frame were rigidly fixed in the known utility model. During transportation, the actuator and pivotable frame fasteners had to be disconnected in order to bring the table through a min. 1,100 mm door opening. After that, the tilt angle sensors settings were disrupted, and the software had to be reset. This table structure provides for settings configuration in the assembly process, and the settings are not disrupted during transportation.

The alidades enable exact angle setting unrelated to the motors during the program coding. The alidades provide for developing a linear mathematical model of the motor/actuator control. The motor mathematical model is not necessarily linear.

The pivotable supports allow for reducing the base shipping dimension from 1,252 mm to 700 mm.

The fencing provides for safe patient accommodation during the procedure.

The fastening mechanism saves the operating personnel the effort of fastening/loosening the patient.

The floor-to-bed distance is reduced to 400 mm (taking into account the mattress height: 600 mm) due to reduction of the base height. This fundamental solution provides for ridding of fixtures used for lifting the patient onto the table. The utility model was comparably high: about 900 mm. A stepstool for the patient had to be used, which was none too convenient. Now, even a not particularly tall patient can to crawl onto the table.

The bed and bed base are longitudinally offset 180-200 mm against the bed pivotable frame in order to secure a safe distance between the floor and bed in the operating 30 degrees tilt angle.

The angle between the rocker arm gussets is increased to 120 degrees, which allows reducing the table assembly height.

The patient's individual vasomotion frequency is measured before treatment, when the patient is in the supine position. The patient is then placed in the right lateral position with legs bent in knees and spread apart in hip joints at 30 or 45 degrees. The table head is declined and reset by continuous tilting at a variable angle of rotation along the table longitudinal and transverse axes. The tilting cycle parameters and the inversion table velocity are estimated according to the patient's individual vasomotion frequency, and set on the control panel. The method provides for efficient treatment and prevention of blood microcirculation disorders in the body by normalizing the high-speed flow of the peripheral blood channel, and by raising the nutritive blood flow share and the number of functioning capillaries.

The patient's vasomotion frequency, as the oscillation frequency of the cutaneous micro blood flow, is measured with a laser flowmeter in the 0.07-0.145 Hz range at four points: the right and left supercilia, the right and left medial epimalleolar areas. The measurements taken in these points reflect the systemic microcirculation (the upper and lower body vascular supply ratios). After that, the maximum amplitude frequency is measured in each point, the average is calculated and set as the table frequency. This frequency will be equal to the frequency of the table longitudinal and transverse tilting motions. The amplitude will increase, if they are impacted with a resonant frequency.

The table maximum tilt angle and the number of continuous cycles are individual parameters for each patient.

For heavy conditions, the tilt angle is lowered to 10.5 degrees, though the number of continuous cycles will be increased to 2-3. For children, the ultimate tilt angle reduction is determined by their fear of high slopes. These aspects expend the table use for various patient groups: babies and patients with heavy somatic pathologies.

The 10.5 degrees angle is calculated based on the table movement algorithm, i.e., the 3-1.5 cycle. Practice shows that patients almost do not feel the 10.5 degree tilt, and it is comfortable for them. The number of cycles is increased with the ultimate tilt angle reduction in order to keep the procedure time same, as with the 30-degree tilt.

### DETAILED DESCRIPTION OF THE PREFERRED EMBODUMENT

Basic technical characteristics of the table.

The table corresponds to the requirements of GOST 20790, technical specifications TU BY 192389051.001-2015, design drawings and documentation.

The table provides for the required operating mode with evenly distributed maximum workload of 150 kg. The table operating mode-setting time does not exceed 3 minutes. The table provides for the following operating mode: 20 minutes—operation, 10 minutes—pause, for at least 8 hours a day.

The table average service life is no less than 5 years. The criterion of the table marginal state is the impossibility or economic unviability of its restoration.

The table climate version is UHL 4.2 according to GOST 15150.

The table is compliant with the safety requirements of GOST 20790-93, STB MEK 60601-1-1-2005, GOST 30324.0-95, Protection Class I, Working Surface Protection Degree V.

The table corresponds to the electromagnetic compatibility requirements of STB MEK 60601-1-2-2006.

The key loadbearing metal structures are made of 20×20×2 and 40×40×2 pipes according to GOST 136630-86 of steel V-St08kp5, GOST 10706-76.

### Table Structure and Operating Modes

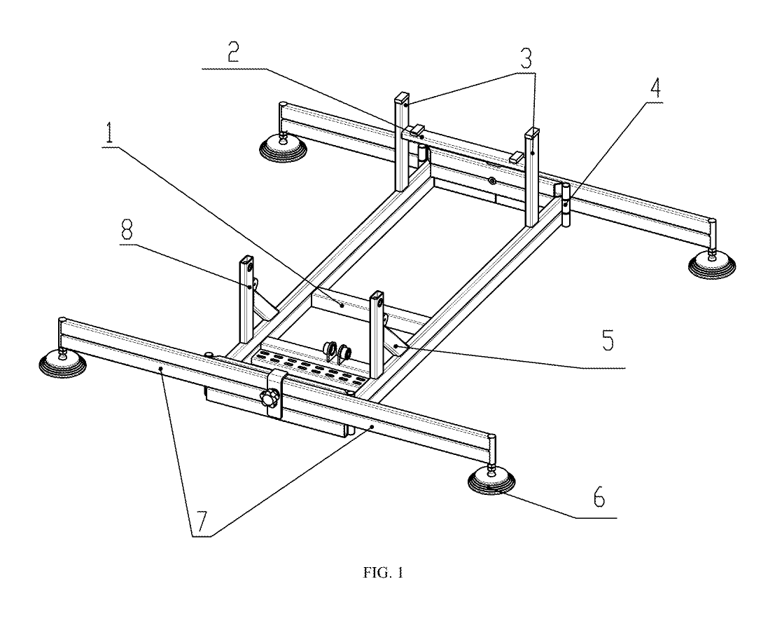

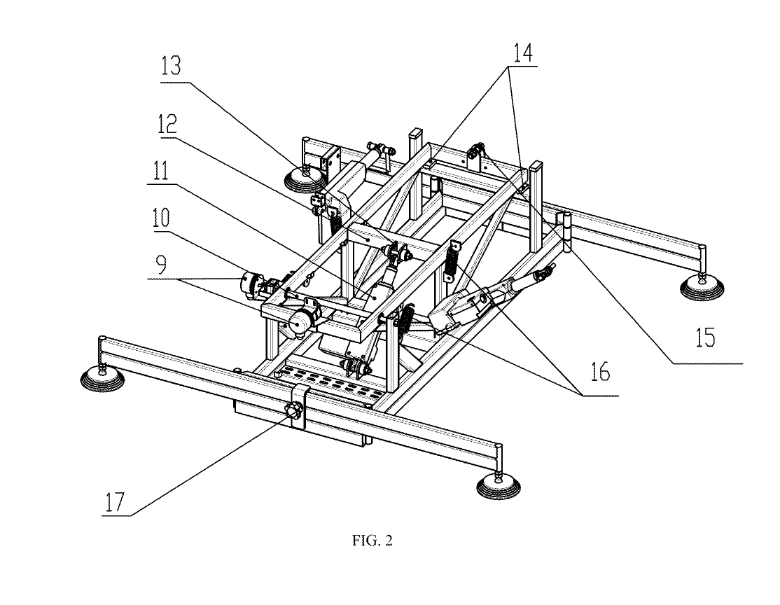

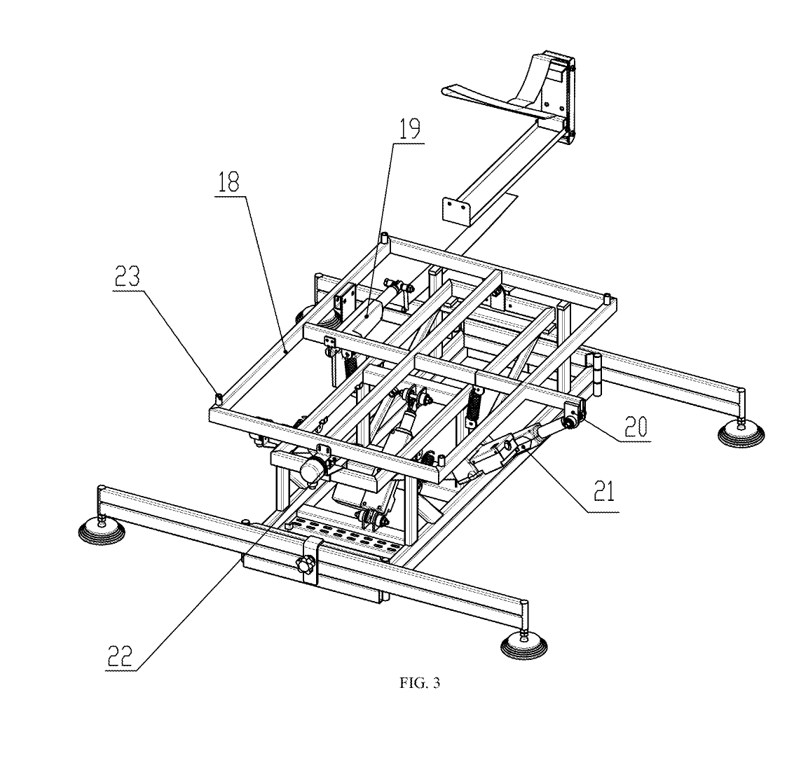

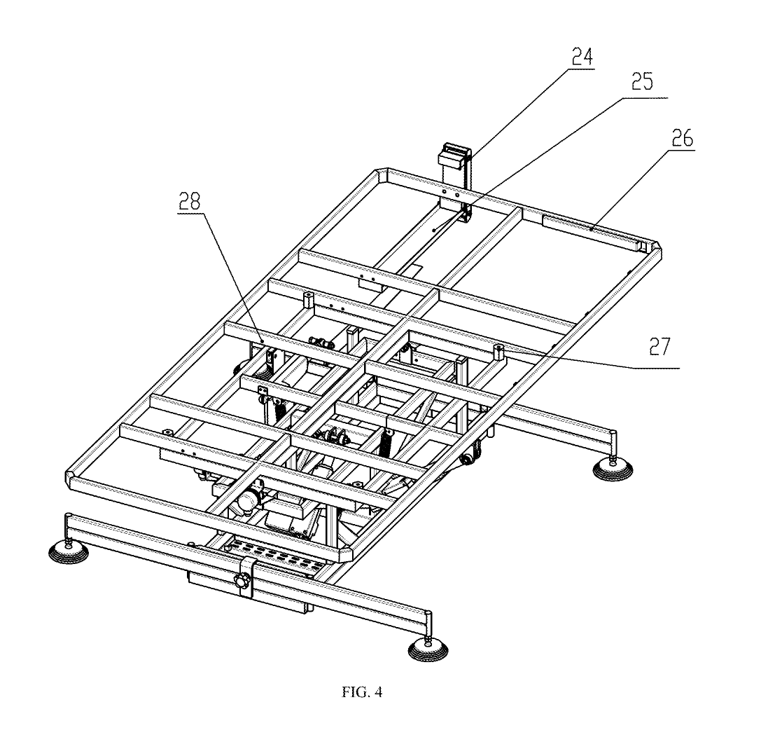

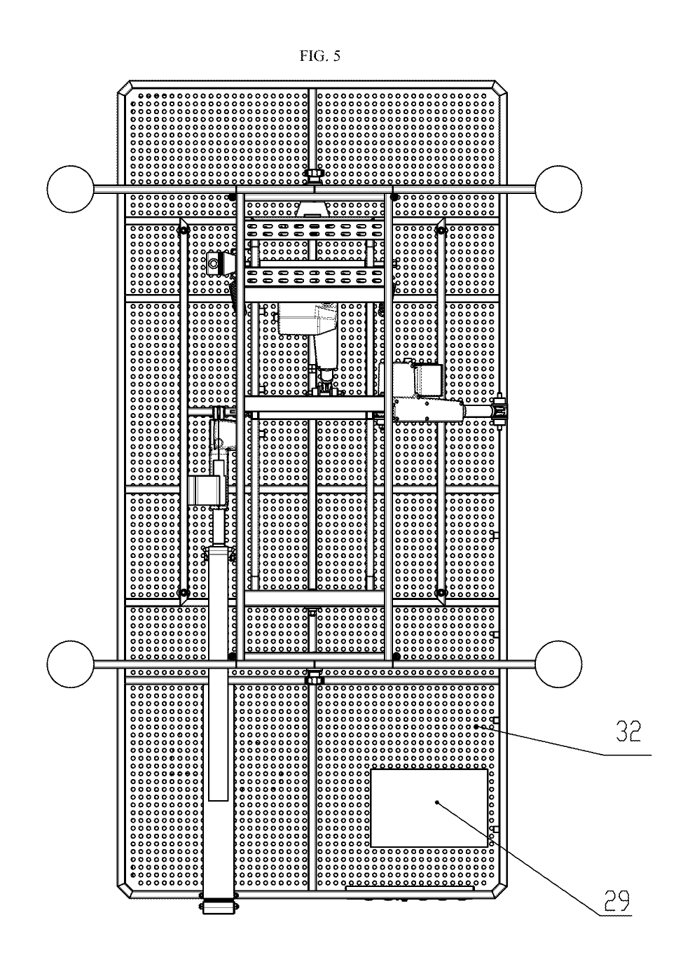

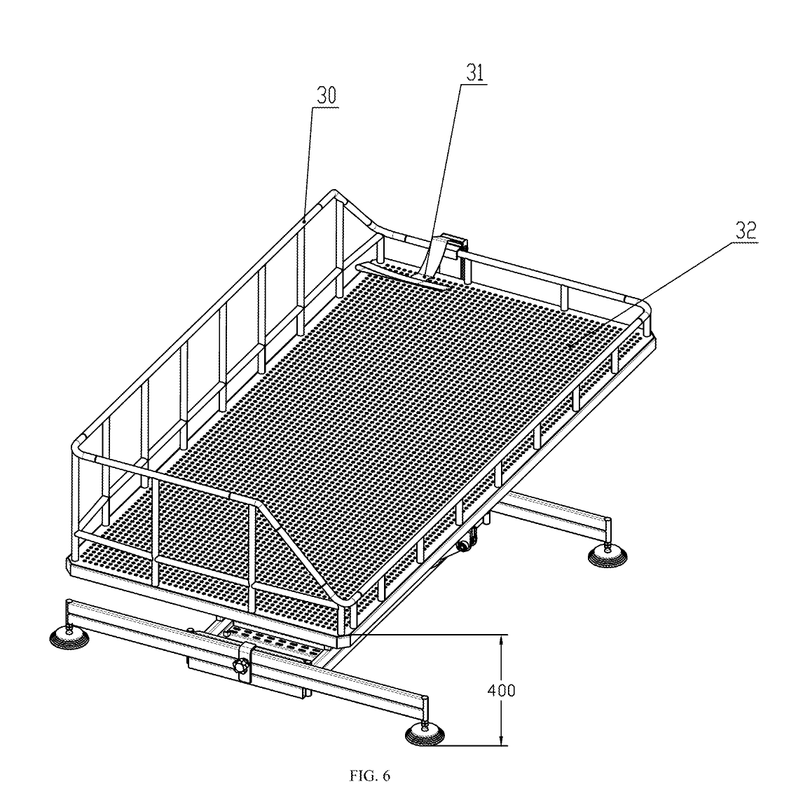

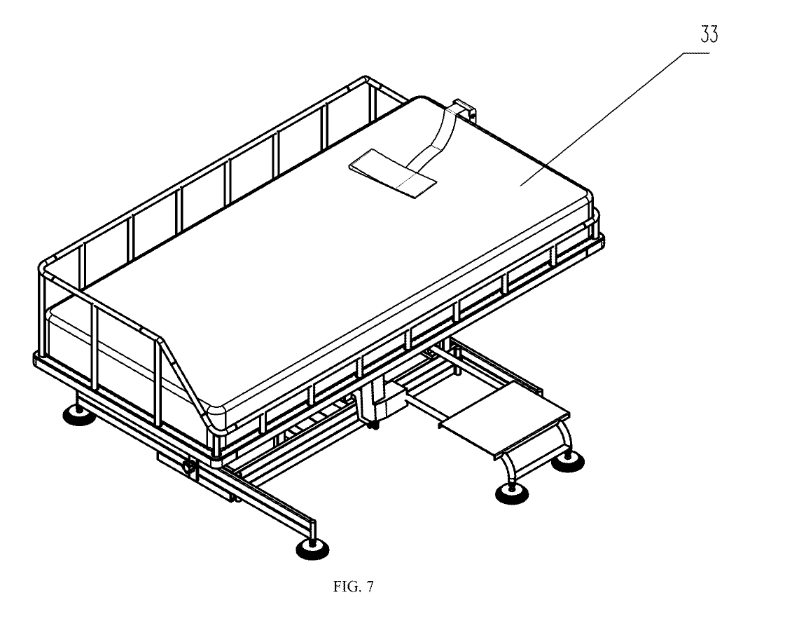

The table consists of base 1 (FIG. 1) and movable platform that serves as the patient's lying surface—bed 32 (FIG. 6). The lying surface is limited with backboards 30 (FIG. 6) at two adjacent side, providing for the patient's comfort and safety. Orthopedic mattress 33 (FIG. 7) made of a shape-memory material provides comfort during the procedure. Waist bandage 31 (FIG. 6) is also included to attach the patient to the safety belt with weight-driven traction. The table layout and configuration are shown on FIG. 1-6.

The table has three actuators with a minimum lifting capacity of 600 kg each.

Actuator 11 (FIG. 2) fixed between base 1 (FIG. 1) and rocker arm 12 (FIG. 2) provides for the bed movement around the table transverse axis.

Actuator 21 (FIG. 3) fixed between rocker arm 12 (FIG. 2) and bed pivotable frame 18 (FIG. 3) provides for the bed movement around the table longitudinal axis.

Actuator 19 (FIG. 3) fixed on bed pivotable frame 18 (FIG. 3) provides for fastening/loosening the patient restraint belt.

The table loadbearing structure is made of steel pipes of various cross-sections, covered with top-grade powdered paint ensuring its harmless use. There is an electronic power supply and control unit in the lower part of the table base.

The electronic circuit diagram of the inversion table control unit is based on modern highly stable electronic components. That ensures high reliability, safety, small dimensions and weight, and the ease of use of the inversion table, accordingly.

Inversion table control panel 26 (FIG. 4) is located on the bed front/foot part.

The table set includes a mattress. In addition, several soft pads (fencing) are placed on the mattress along the bed long and short sides for the patient's comfort.

The patient's thigh-spreading fixtures are tetrahedron-shaped, which provides for the patient's thigh spreading at a 30- or 45-degree angle, and they are made with non-traumatic materials preventing from compression of major neurovascular braids.

Operating mode (parameters of the bed base movements):
the table operates continuously, at a set cycle, in a see-saw motion. The mini-cycle “bed base rotation to the right and left against the longitudinal axis” is repeated up to a 30-degree tilt against the transverse axis. After the 30-degree tilt, the motion cycle is resumed in reverse order until the bed returns to the original horizontal position.
the full operating cycle of the bed base motions (to 30 degrees and back to the horizontal position) takes 20 minutes.

The table is operated as follows
the table is automatically calibrated after the power connection is made, and the on/off button (ON/OFF) on the control panel (FIG. 7) is pressed. When the auto-calibration is over, the table bed will automatically assume its horizontal position.
the patient is on the bed lying surface with their head on the pillow, in the right lateral position, with their lower extremities bent in hip and knee joints, and the patient is secured with the safety belt to prevent them from shifting.
the thigh-spreading fixture (the tetrahedron) is placed between the thighs providing for the thigh-spreading angle of 30 or 45 degrees: 45 degrees for patients under 40 years of age, 30—for patients over 40 years of aged, or for children
after the patient is properly positioned, and the table is turned on by drives/actuators, the bed will commence the motion cycle in two planes. The bed is tilted and lifted phase-by-phase in longitudinal and transverse directions. as a result of a ten-minute cycle of such motions, the bed gradually tilts the patient head down to an angle of 30 degrees, after that it will perform similar motion cycles to return them to the original/horizontal position also taking ten minutes.

### EXAMPLE 1

Female patient, 82 years. Diagnosis: 5^{th} degree chronic lymphovenous insufficiency of the lower extremities, trophic ulcer of the left shin for 3 years.

### EXAMPLE 2

Patient, 58 years. 1.5-year history of ischemic-type acute cerebrovascular event in the area of the right medial cerebral artery, left-sided hemiparesis.

### EXAMPLE 3

Patient, 48 years. Diagnosis: obliterating atherosclerosis of the lower extremity vessels, dystonic form.

### EXAMPLE 4

Patient, 67 years. Diagnosis: varix of the lower extremities, third-degree chronic venous insufficiency. Examination findings: edema in the shin and foot area, more expressed in the area of the left lower extremity.

What is claimed is:

1. An inversion table comprising: a bed with a pivotable frame, a support element hinged to actuators providing for a bed longitudinal and transverse tilting; it has a soft-material fastening element fixed in a pelvic area; it is distinguished by a support element base shaped as a rectangular flat frame structure with hinged corners for mounting pivotable console supports which enlarge the support base; there are two support stands with struts and two support stands linked with a traverse bar near the corners on the long opposite sides of the base flat frame structure; a rocker arm is mounted with bearing on an axis linking strutted support stands, while a rocker arm drive actuator, which provides for transverse tilting, is attached to the base, and a pivotable frame drive actuator, which provides for longitudinal tilting, is attached to the rocker arm; rocker arm alidades are lined with the rocker arm and pivotable frame axes; the bed is rigidly attached to the pivotable frame with a longitudinal shift provided by the bed fasteners and bolts.

2. The inversion table according to claim 1 is distinguished by a level mounted on a bed rear side, and each console support provided with a height-adjustable stand.

3. The inversion table according to claim 1 is distinguished by a console stand locking in with a retainer plate and a star knob.

4. The inversion table according to claim 1 is distinguished by bed fastening elements: four bushings enabling installation on four pivotable frame tubes, while the bushings are drilled through and threaded on an end for bolting down the bed.

5. The inversion table according to claim 1 is distinguished by a bed fencing.

6. The inversion table according to claim 1 is distinguished by a fastening element in the pelvic area that serves as a safety belt.

7. The inversion table according to claim 6 is distinguished by an attachment of the actuator to the pivotable frame for fastening/loosening the safety belt.

8. The inversion table according to claim 1 is distinguished by a control unit with a built-in flowmeter.

9. The inversion table according to claim 1 is distinguished by the bed longitudinal shift against the pivotable frame to 180-200 mm.

10. A method for treating and preventing peripheral circulation disorders that provides for a patient placement on an inversion table in a right lateral position with legs bent in knees and spread in hip joints; a table head part inclines to an angle of 30 degrees and returns to an original position by making tilting motions around a longitudinal and transverse axes at a set frequency, is distinguished by the patient placement on the inversion table in accordance with claim 1, with legs spread apart in hip joints at 30 or 45 degrees, and the frequency is set as equal to the average maximum oscillation frequency of a cutaneous micro blood flow at a maximum amplitude.

11. The method for treating and preventing peripheral circulation disorders according to claim 9 is distinguished by the frequency of the cutaneous micro blood flow oscillation measured by a laser flowmeter in a 0.07-0.145 Hz range at four points: a right and a left supercilia, a right and a left medial epimalleolar areas.

12. The method for treating and preventing peripheral circulation disorders according to claim 9 is distinguished by a 20-minute session period.

13. The method for treating and preventing peripheral circulation disorders according to claim 12 is distinguished by a 10-minute tilting period.
